(19) United States
(12) Patent Application Publication
(10) Pub. No.: US 2008/0099509 A1
(43) Pub. Date: May 1, 2008

(54) COFFEE GROUND DISPENSER

(76) Inventor: CHARLES MOUNTJOY, BUCKNER, MO (US)

Correspondence Address: HOVEY WILLIAMS LLP, 10801 Mastin Blvd., Suite 1000, Overland Park, KS, 66210, US

(21) Appl. No.: 11/554,644

(22) Filed: Oct. 31, 2006

(51) Int. Cl. B67D 5/38; G01F 11/28

(52) U.S. Cl. 222/158; 222/450

(57) ABSTRACT

A dispenser (10) includes a hopper (12) for storing dispenser contents, a removable hopper lid (14) forming a substantially air-tight seal with the hopper (12), and a dispensing chamber (16). The dispensing chamber (16) includes a first door (66) for allowing the contents to pass from the hopper (12) to the chamber (16) when open and forming a substantially air-tight seal between the chamber (16) and the hopper (12) when closed, a second door (72) for allowing the contents to leave the chamber (16) when open and retaining the contents in the chamber (16) when closed, and a measuring mechanism (56) for measuring an amount of contents in the dispensing chamber (16).

### BACKGROUND OF THE INVENTION

1. Field of the Invention

Embodiments of the present invention relate to the field of dispensers. More particularly, embodiments of the present invention involve a dispenser for maintaining a food ingredient or other contents in an air-tight storage arrangement and conveniently dispensing a portion of the contents with minimal exposure of the remaining stored contents to ambient air.

2. Description of Prior Art

Coffee grounds, drink mixes, and other food items or ingredients tend to degrade in quality when exposed to ambient air. Continuous exposure to ambient air, for example, cause coffee grounds to lose flavor, and exposure to ambient humidity can cause drink mixes and other powders to crystalize, rendering them difficult or impossible to use.

Containers for such ingredients often provide airtight seals, but such seals must be broken, at least temporarily, to access the ingredients. Coffee grounds, for example, can be purchased in a can that is capped with a plastic lid after opening. The plastic lid forms a temporary air-tight seal, but when the user wishes to access the coffee grounds to make more coffee the lid must be removed, newly exposing the coffee grounds in the can to ambient air. Repeatedly exposing the coffee grounds to ambient air in this manner causes the coffee grounds degrade in quality.

Accordingly, there is a need for an improved dispenser that does not suffer from the problems and limitations of the prior art.

### SUMMARY OF THE INVENTION

The present invention provides an improved dispenser for substances that benefit from isolation from the ambient air. Particularly, the present invention provides a dispenser for maintaining a food ingredient or other contents in an air-tight storage arrangement and conveniently dispensing a portion of the contents with minimal ambient air reaching the remaining stored contents.

The dispenser includes a hopper for storing dispenser contents, a removable hopper lid forming a substantially air-tight seal with the hopper, and a dispensing chamber. The dispensing chamber includes a first door for allowing the contents to pass from the hopper to the chamber when open and forming a substantially air-tight seal between the chamber and the hopper when closed, a second door for allowing the contents to leave the chamber when open and retaining the contents in the chamber when closed, and a measuring mechanism for measuring an amount of contents in the dispensing chamber.

These and other important aspects of the present invention are described more fully in the detailed description below.

### BRIEF DESCRIPTION OF THE DRAWINGS

An embodiment of the present invention is described in detail below with reference to the attached drawing figures, wherein:

FIG. 1 is an isometric view of a dispenser incorporating principles of the present teachings, wherein a dispenser lid is illustrated separated from a dispenser hopper;

FIG. 2 is a fragmentary view of the dispenser of FIG. 1;

FIG. 3 is a front elevation view of the dispenser of FIG. 1;

FIG. 4 is a top plan view of the dispenser of FIG. 1 without the lid;

FIG. 5 is a cross-sectional view of the dispenser of FIG. 1 taken substantially along line 5-5 of FIG. 3, illustrating the dispenser supported by a mounting plate secured to a wall;

FIG. 6 is a cross-sectional view of the dispenser of FIG. 1, illustrating contents in the dispenser hopper and an upper door sliding to an open position to allow the contents to pass from the hopper to a dispensing chamber;

FIG. 7 is a cross-sectional view of the dispenser of FIG. 6, illustrating a portion of the contents in the dispensing chamber and the upper door sliding to a closed position to prevent further contents from passing from the hopper to the dispensing chamber;

FIG. 8 is a cross-sectional view of the dispenser of FIG. 7, illustrating a lower door sliding to an open position to allow the contents of the dispensing chamber to fall out of the dispensing chamber;

FIG. 9 is a cross-sectional view of the dispenser of FIG. 8, illustrating the contents of the dispensing chamber failing out of the dispensing chamber and the lower door sliding to a closed position;

FIG. 10 is an isometric view of the dispenser of FIG. 1 further comprising a stand for supporting a hopper and dispensing chamber of the dispenser;

FIG. 11 is the dispenser of FIG. 10, illustrating the hopper and dispensing chamber separate from the stand;

FIG. 12 is an isometric view of a first alternative implementation of a dispenser incorporating principles of the present teachings, wherein the dispenser includes a handle; and

FIG. 13 is an isometric view of a second alternative implementation of a dispenser incorporating principles of the present teachings.

### DETAILED DESCRIPTION

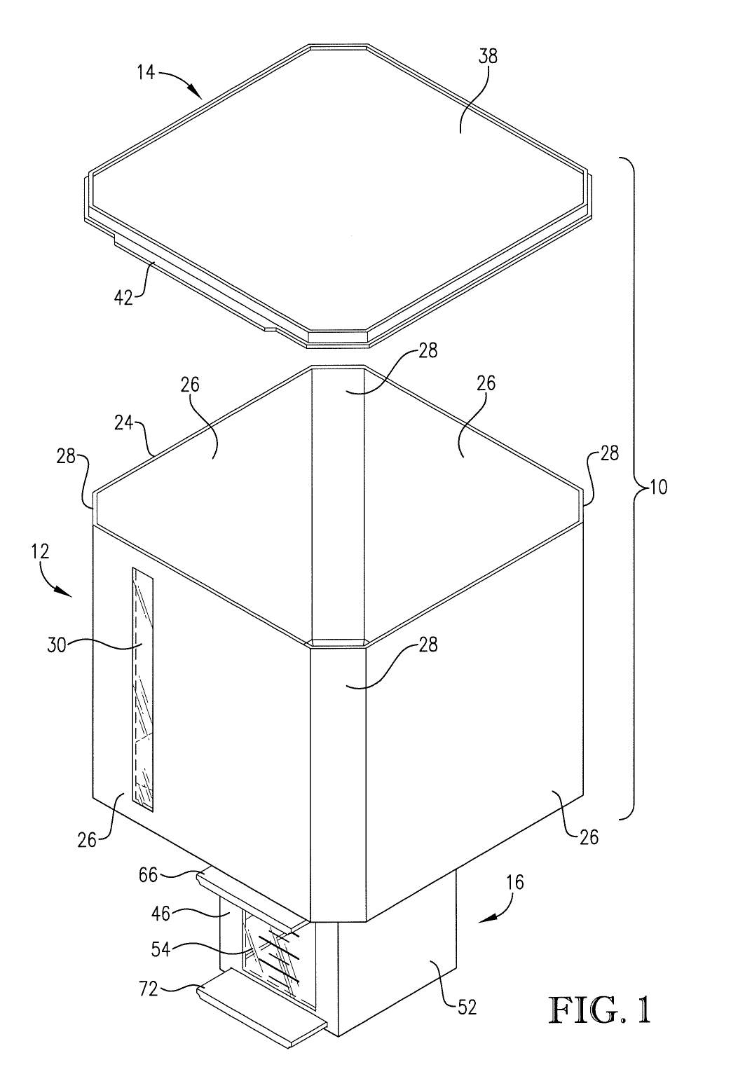

A dispenser incorporating principles of the present teachings is illustrated in FIG. 1 and designated generally by the reference numeral 10. The dispenser 10 is operable to store contents in an air-tight or substantially air-tight environment and conveniently dispense a portion of the contents with minimal ambient air reaching the remaining stored contents. Therefore, the dispenser 10 is especially well-suited for use with dry, granulated substances that benefit from minimal exposure to ambient air such as cooking ingredients or other food items, including, for example, coffee grounds, drink mixes, and spices. The dispenser 10 generally comprises a hopper 12, a lid 14, and a dispensing chamber 16.

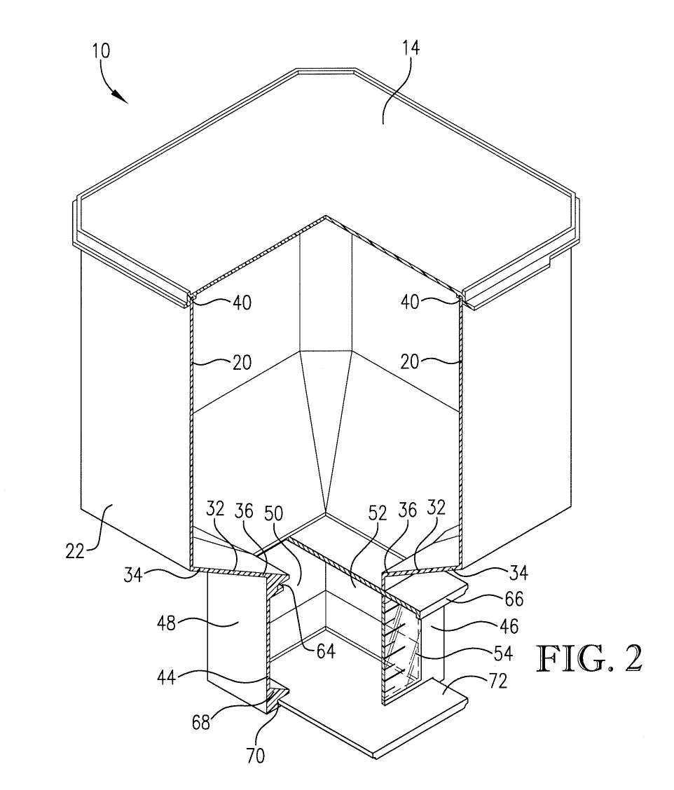

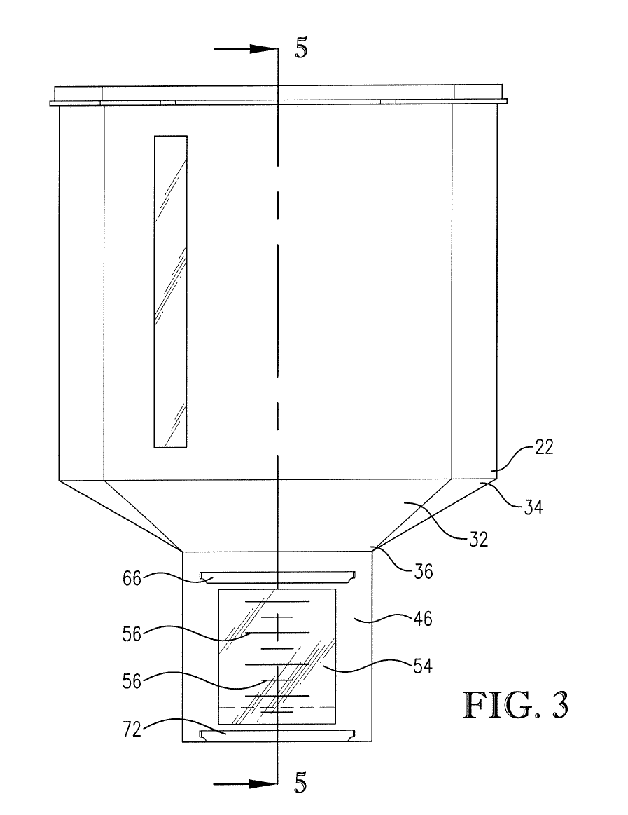

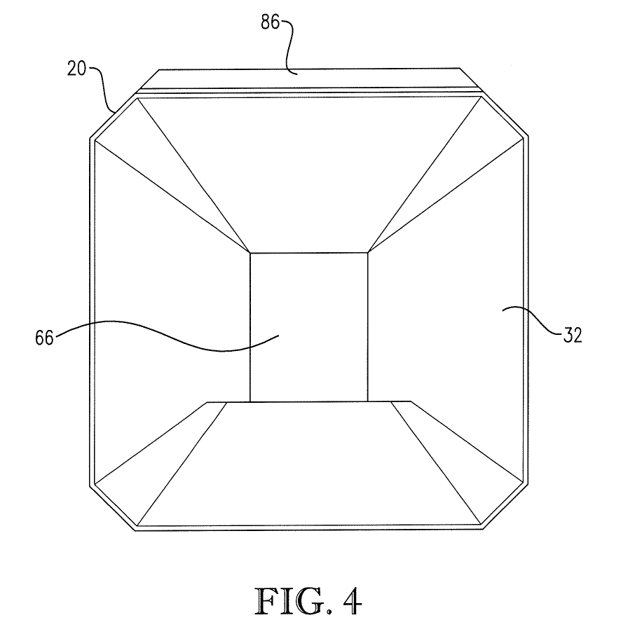

Referring also to FIGS. 2-5, the hopper 12 provides an air-tight or substantially air-tight storage space for storing contents. The hopper 12 comprises a first continuous peripheral wall 20 that includes a base 22, an upper edge 24, a plurality of face sections 26, a plurality of corner sections 28, and a transparent portion 30. The hopper 12 further comprises a sloping peripheral wall 32 with a top 34 and a base 36.

Each of the illustrated plurality of face sections 26 is substantially rectangular with a width preferably within the range of about two inches to about sixteen inches, more preferably within the range of about three inches to about twelve inches, even more preferably within the range of about four inches to about eight inches, and most preferably about five and one-half inches. Each face section 26 has a height that is preferably within the range of about two inches to about sixteen inches, more preferably within the range of about three inches to about twelve inches, even more preferably within the range of about four inches to about eight inches, and most preferably about six inches.

The face sections 26 are interconnected by the plurality of corner sections 28. Each of the corner sections 28 has approximately the same height as the face sections 26. For example, if the face sections 26 are each six inches tall, the edge sections 28 are also about six inches tall. Each of the corner sections 28 has a width that is generally less than that of the face sections 26. The width of each of the corner sections 28 is preferably within the range of about one-fourth of an inch to about three inches, more preferably within the range of about one-half inch to about two and one-half inches, even more preferably within the range of about three-fourths of an inch to about two inches, and most preferably about one inch. Each of the illustrated face sections 26 is at a 90° angle to the two adjoining face sections 26. Each corner section 28 forms a 135° angle with each face to which it is connected. One or more of the face sections 26 may include a transparent portion 30 to allow a user to view the contents of the hopper 12 in order to ascertain an amount of the contents.

The sloping peripheral wall 32 extends inwardly from the base 22 of the first peripheral wall 20 toward a top portion of the dispensing chamber 16 to form a funnel that directs contents of the hopper 12 into the dispensing chamber 16. Thus, the top 34 of the sloping peripheral wall 32 adjoins the base 22 of the first peripheral wall 20, and the base 36 of the sloping peripheral wall 32 adjoins a top of the dispensing chamber 16.

The first peripheral wall 20 and the sloping peripheral wall 32 illustrated and described herein are exemplary in nature. Those skilled in the art will recognize that the hopper 12 may present virtually any shape including, for example, a square, round, ovular, or other shape, including arbitrary shapes.

The lid 14 includes a web portion 38 and a downwardly-opening channel 40 that engages the upper edge 24 of the first peripheral wall 20 to create an air-tight or substantially air-tight seal. The channel 40 is substantially continuous and is proximate a periphery of the lid 14. The lid 14 includes a handle 42 to facilitate removal of the lid from the hopper 12. The channel 40 of the lid 14 should have a depth sufficient to allow a snug, air-tight or substantially air-tight connection between the lid 14 and the first peripheral wall 20. The depth of the channel 40 is preferably within the range of about 0.010 inches to about 1.0 inches, more preferably within the range of about 0.1 inches to about 0.8 inches, even more preferably within the range of about 0.2 inches to about 0.5 inches, and most preferably about 0.25 inches.

It will be appreciated that the illustrated channel 40 is only one exemplary means of creating an air-tight or substantially air-tight seal between the lid 14 and the wall 20, and that various other implementations of the present teachings may be used to create an air-tight seal between the lid 14 and the wall 20 without departing from the scope of the claimed invention. For example, a gasket (not shown) may be secured to the lid 14, to the wall 20, or both, to ensure a snug, air-tight fit between the lid 14 and the wall 20. Such a gasket may be used instead of or in addition to the channel 40.

The dispensing chamber 16 generally defines a passage out of the hopper 12 through which the contents 18 of the hopper 12 pass when dispensed. The dispensing chamber 16 further provides an air-tight or substantially air-tight seal when closed to minimize exposure of the contents remaining in the hopper 12 to ambient air. The dispensing chamber 16 further includes a measuring mechanism for measuring an amount of contents in the chamber 16 to assist users in controlling the amount of contents 18 dispensed from the hopper 12.

The dispensing chamber 16 includes a peripheral chamber wall 44 that includes a first side 46, a second side 48, a third side 50, and a fourth side 52. At least a portion of the chamber wall 44 may be substantially transparent to allow a user to view the contents of the dispensing chamber 16, which is useful to enable the user to regulate the amount of contents 18 dispensed. The illustrated transparent portion 54 is located on the first side 46 of the peripheral chamber wall 44 and includes a plurality of measurement indicia 56, discussed in greater detail below.

The illustrated chamber wall 44 presents a generally rectangular footprint and each side 46, 48, 50, 52, of the wall 44 is generally rectangular in shape. Specifically, the illustrated chamber wall 44 is substantially cube-shaped. The length, width, and height of the illustrated chamber wall 44 is each preferably within the range of about one inch to about five inches, more preferably within the range of about two inches to about four inches, and most preferably about three inches. Thus, the dispensing chamber 16 is generally smaller than the hopper 12.

The illustrated measurement indicia 56 are presented on the transparent portion 54 of the wall 44 and represent fill level marks that indicate an amount of the contents 18 in the dispensing chamber 16. The measurement indicia 56 may indicate, for example, one or more units of measurement, such as one-fourth of a measuring cup, one-half of a measuring cup, three-fourths of a measuring cup, and one measuring cup. Alternatively, the measurement indicia 56 may indicate an amount of contents corresponding to a specific mixing regimen such as, for example, one cup of brewed coffee, two cups of brewed coffee, three cups of brewed coffee, and so forth. The measurement indicia 56 may be on the transparent portion 54 of the wall 44 as illustrated, or, alternatively, may be on an outer surface of the chamber wall 44 other than the transparent portion 54 or on an inner surface of the chamber wall 44 other than the transparent portion 54. Furthermore, any combination of these locations may be used.

The dispensing chamber 16 includes an upper door slot 58 and a lower door slot 60. The upper door slot 58 is generally located proximate an entrance of the dispensing chamber 16, while the lower door slot 60 is located proximate an exit of the dispensing chamber 16. As explained below in greater detail, the upper door slot 58 and the lower door slot 60 are each approximately the same size as a cross section of a corresponding door to provide a snug, substantially air-tight fit. While the upper door slot 58 and the lower door slot 60 are illustrated on the first side 46 of the chamber wall 44, it will be appreciated that the door slots 58, 60 may be located on any side of the peripheral chamber wall 44 and each door slot 58,60 may be located on a different side. Such alternative implementation is well within the scope of the claimed invention.

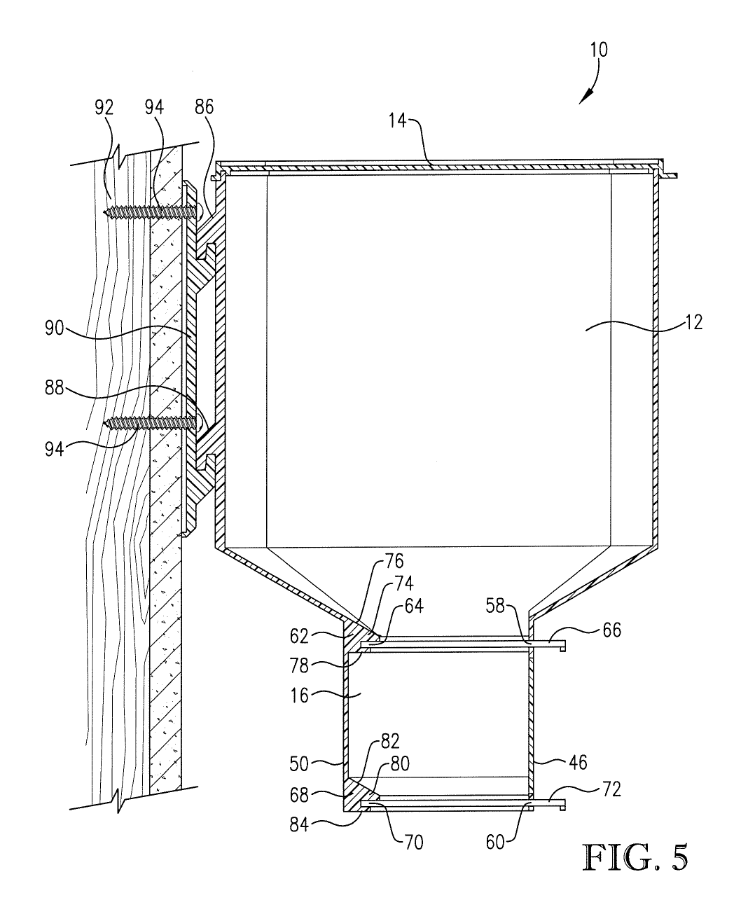

Referring particularly to FIGS. 2 and 5, the dispensing chamber 16 further comprises an upper rib 62 and a lower rib 68. The upper rib 62 extends inwardly from an inside of the chamber wall 44 proximate a top of the chamber wall 44. The upper rib 62 runs from a first end of the upper door slot 58 along sides of the chamber wall 44 that do not include the upper door slot 58, to a second end of the upper door slot 58 such that the upper rib 62 and the upper door slot 58 taken together substantially completely encircle the dispensing chamber 16. Specifically, the illustrated upper rib 62 runs along the second, third, and fourth sides 48,50,52 sides of the chamber wall 44 while the upper door slot is located on the first side 46 of the chamber wall 44.

The upper rib 62 presents a substantially continuous, inwardly-opening upper channel 64 aligned with the upper door slot 58 such that when a flat upper door 66 is inserted through the upper door slot 58 it is entrained in the upper channel 64. The upper rib 62 includes an upper lip 74, an upper surface 76 of the upper lip 74, and a lower lip 78. The upper lip 74 extends inwardly further than the lower lip 78, and the upper surface 76 of the upper lip 74 slopes generally downwardly and inwardly from the chamber wall 44 to an innermost edge of the upper rib 62. The sloping upper surface 76 prevents contents from getting stuck on the surface 76. Because the upper lip 74 overhangs the lower lip 78, contents passing into the dispensing chamber 16 from the hopper 12 fall past the upper channel 64, thus avoiding content accumulation in the upper channel 64.

The dispensing chamber 16 further comprises a lower rib 68 that is substantially similar to the upper rib 62, except that the lower rib 68 is located near an exit of the dispensing chamber 16. The lower rib 68 includes an upper lip 80, an upper surface 82 of the upper lip 80, and a lower lip 84. As with the upper rib 62, the upper lip 80 and the lower lip 84 of the lower rib 68 define an inwardly-opening lower channel 70, wherein the upper lip 80 extends inwardly further than the lower lip 84, such that contents passing over the lower rib 68 and out of the dispensing chamber 16 fall past the lower channel 70, thus avoiding content accumulation in the lower channel 70.

The upper door 66 is substantially flat and sized to fit snugly within the upper door slot 58 and the upper channel 64 such that when in a closed position the upper door 66 prevents contents from passing from the hopper 12 to the dispensing chamber 16 and creates an air-tight or substantially air-tight seal between the dispensing chamber 16 and the hopper 12. Likewise, the lower door 72 is substantially flat and sized to fit within the lower channel 70 such that when in an opened position, contents of the dispensing chamber 16 are allowed to exit a bottom of the dispensing chamber. When in the closed position, the door 72 creates an air-tight or substantially air-tight seal between the dispensing chamber 16 and the environment surrounding the dispenser 10.

Referring particularly to FIG. 5, the dispenser 10 may include a mechanism for mounting the dispenser 10 on a wall or other surface. The illustrated mounting mechanism includes a plurality of mounting brackets 86,88 for removably supporting the dispenser 10 on a mount 90 secured to a wall 92 or similar structure via a plurality of wood screws 94 or other attachment means.

The dispenser 10 may be constructed of a variety of different materials including, for example, plastic, nylon, rubber, and metal. Use of a flexibly rigid material for the channel 40 and the wall 20 may enhance the air-tight seal between the channel 40 and the wall 20. In a first exemplary implementation, the dispenser 10 is constructed entirely of plastic. In a second exemplary implementation, the dispenser 10 is constructed of aluminum except for the lid 14, the upper door 66, and the lower door 72, which are constructed of plastic or rubber to enhance the ability of the lid 14 and doors 66,72 to form an air-tight seal with other elements of the dispenser 10.

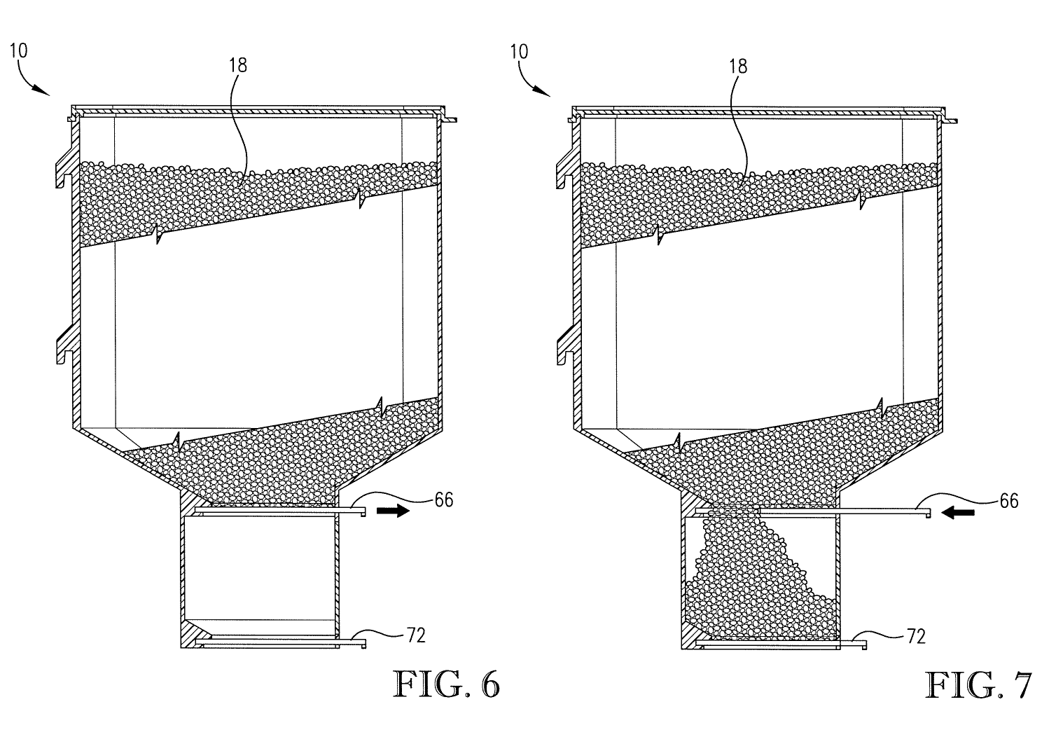

In use, a user first removes the lid 14 and fills the hopper 12 with contents 18. FIGS. 6-9 illustrate the hopper 12 partially filled with the contents 18. As illustrated in FIGS. 6 and 7, a portion of the contents 18 is dispensed from the hopper 12 when the upper door 66 is first moved from a closed position to an open position as illustrated by the arrow in FIG. 6, wherein a portion of the contents 18 of the hopper 12 pass from the hopper 12 into the dispensing chamber 16. The user can monitor and regulate the amount of contents in the dispensing chamber 16 by viewing a fill level of the dispensing chamber 16 via the transparent portion 54 of the chamber wall 44 and using the measurement indicia 56. When the desired amount of contents have entered the dispensing chamber 16, the user closes the upper door 66 to stop the flow of contents from the hopper 12 to the dispensing chamber 16, as illustrated by the arrow of FIG. 7.

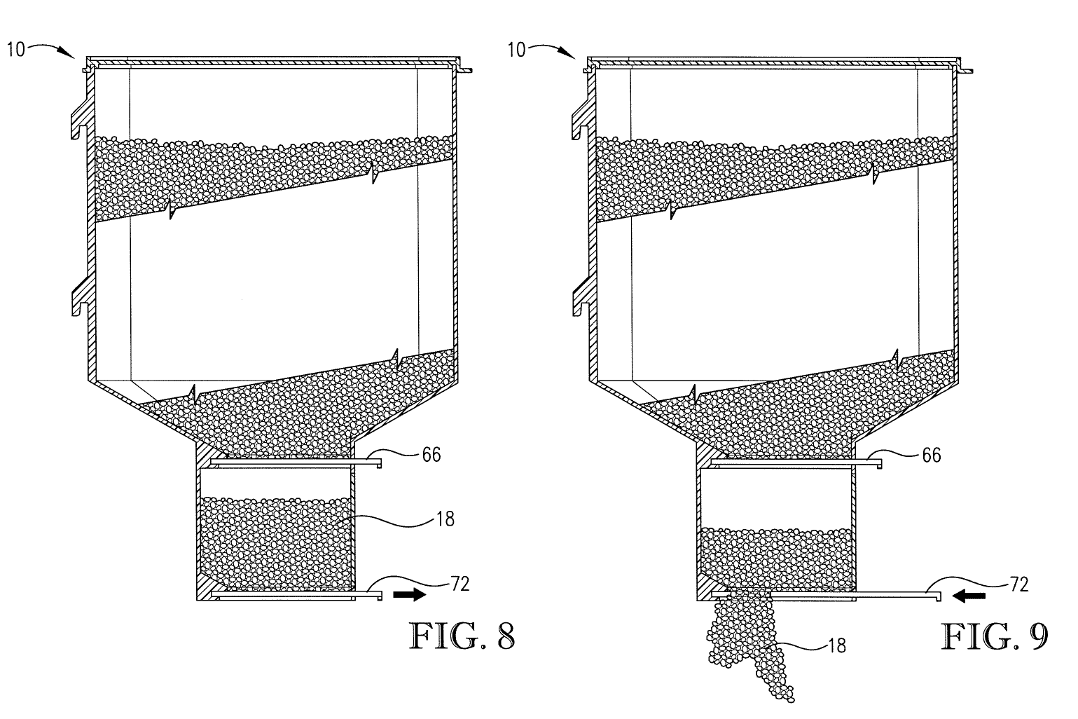

To dispense the contents 18 that have passed from the hopper 12 to the dispensing chamber 16, the user opens the lower door 72, as illustrated by the arrow in FIG. 8, to allow the contents 18 to pass out of the dispensing chamber 16. When the contents have passed out of the dispensing chamber 16, the user closes the lower door 72 as indicated by the arrow of FIG. 9. As can be seen in FIGS. 6-9, the process of dispensing contents from the dispenser 10 results in only minimal exposure of the contents 18 remaining in the hopper 12 to ambient air. For example, the lid 14 is not removed each time the contents are dispensed, but rather the upper door 66 and the lower door 72 are each partially opened, wherein contents of the hopper 12 immediately pass from the hopper 12 to the dispensing chamber 16. The amount of air passing through the dispensing chamber 16 into the hopper 12 is minimized by immediately closing the upper door 66 when the desired amount of contents have passed from the hopper 12 to the dispensing chamber 16.

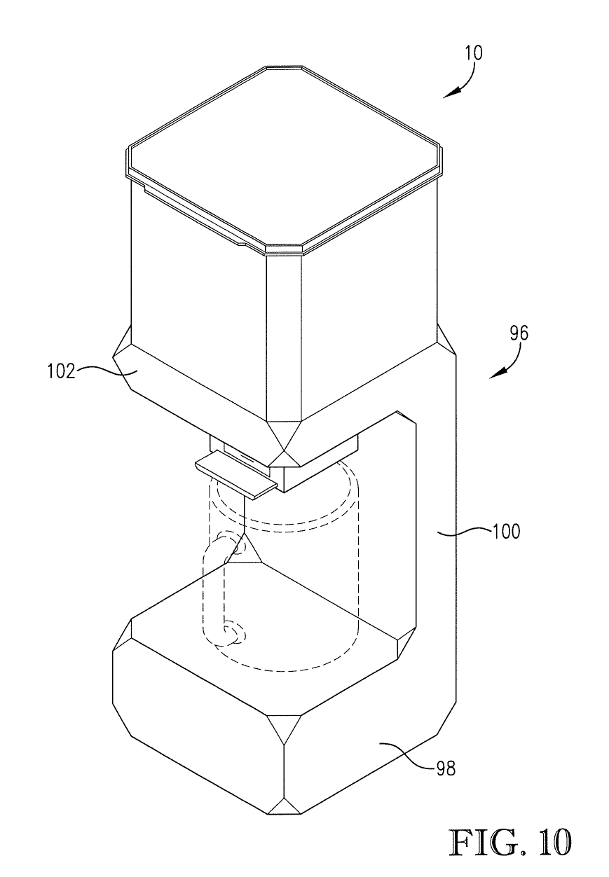

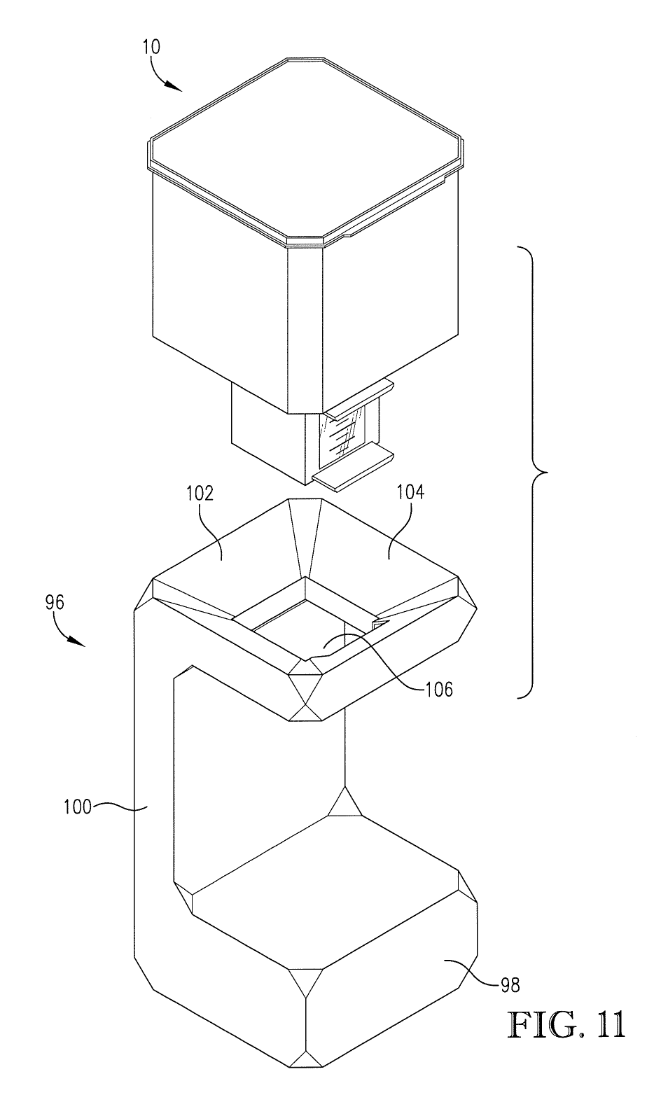

Referring now to FIGS. 10 and 11, the dispenser 10 may further include a stand 96. The stand 96 is configured to support the hopper 12 and the dispensing chamber 16 in a position to allow a user to place a cup, pot, or other container below the dispensing chamber 16 to collect contents dispensed via the dispensing chamber 16. The stand 96 generally comprises a base 98, a neck 100, and a cradle 102 that includes a support portion 104 and an aperture 106.

The base 98 is substantially rectangular and presents a flat upper surface on which the container rests during the dispensing process. The neck 100 generally extends upwardly from an edge of the base 98 to leave room for the container to be placed at or near a center of the base 98. The cradle 102 supports the hopper 12 and the dispensing chamber 16 at a sufficient height above the base 98 to allow a user to place the container on the base 98. The cradle 102 is substantially concentric with the base 98 so that when the hopper 12 and dispensing chamber 16 rest in the cradle 102, the container placed on the base 98 is below and substantially in line with a bottom of the dispensing chamber 16. By way of example, a coffee ground filter or coffee mug may be placed on the base 98 to collect coffee grounds, instant coffee mix, or other drink mix dispensed via the dispensing chamber 16. Alternatively, a mixing bowl or a pot may be placed on the base 98 to collect spices or other ingredients dispensed via the dispensing chamber 16.

The cradle 104 presents an upper surface that substantially conforms to an outer surface of the sloping peripheral wall 32 of the hopper 12 such that the hopper 12 rests securely on the cradle 104. The cradle 104 further presents a recess corresponding to the first side 46 of the peripheral chamber wall 44 of the dispensing chamber 16 to allow the lower door 72 and the upper door 66 to pass through the aperture 106 while in a closed position. The hopper 12 may rest on the cradle 104 without being attached thereto, or may be secured to the cradle 104. Using the stand 98, a user may remove the hopper 12 and the dispensing chamber 16 from the stand 96 in order to facilitate filling the hopper 12 with contents. When the hopper 12 is thus filled with contents, the user places the hopper 12 and the dispensing chamber 16 back on the cradle 104 for dispensing.

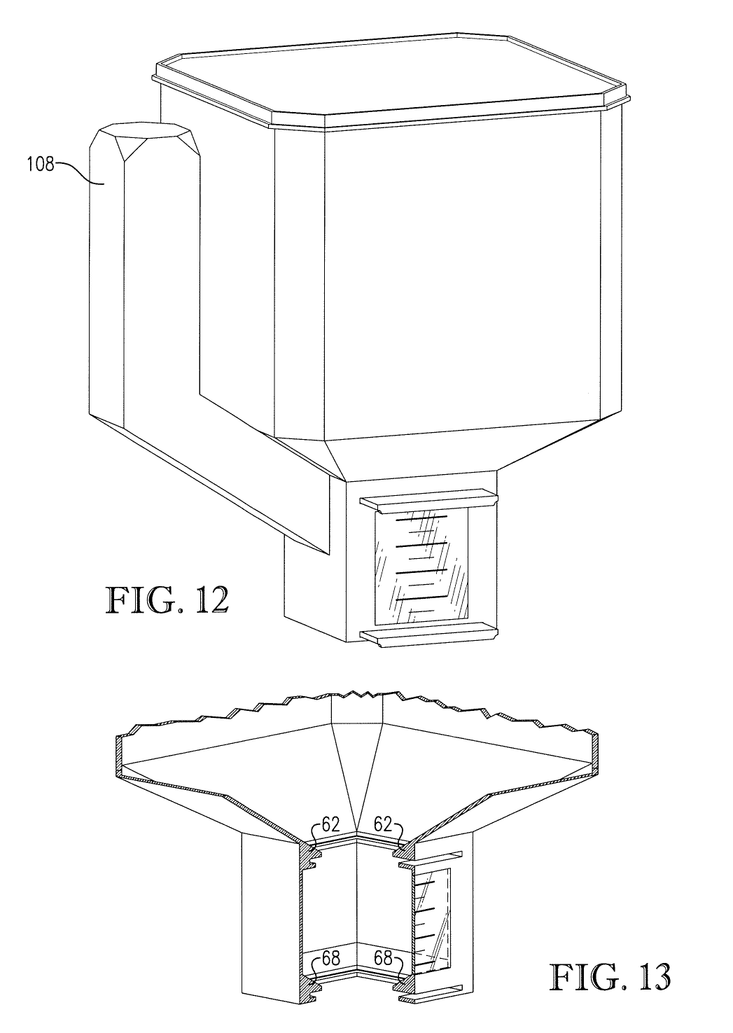

FIG. 12 illustrates a second embodiment of the dispenser 10 that includes a handle 108 extending along a side of the dispenser 10. The handle 108 facilitates use of the dispenser 10 when, for example, the user wishes to hold the dispenser 10 above the pot, bowl, or cup, to be filled with contents. FIG. 13 illustrates a third embodiment of the dispenser 10, wherein the upper rib 62 and the lower rib 68 run substantially entirely around the chamber wall 44, including along the upper door slot 58 and the lower door slot 60, respectively. Thus, the upper lip 70 of the upper rib overhangs the upper door slot 58, and the upper lip 80 of the lower rib 68 overhangs the lower door slot 60.

Although the invention has been described with reference to the preferred embodiments illustrated in the attached drawings, it is noted that equivalents may be employed and substitutions made herein without departing from the scope of the invention as recited in the claims. It will be appreciated, for example, that the dispenser of the present teachings is not limited to use with coffee grounds, spices, or any other particular substance but is useful with virtually any type of contents including, for example, household and commercial non-food substances.

Having thus described a preferred embodiment of the invention, what is claimed as new and desired to be protected by Letters Patent includes the following:

1. A dispenser comprising:
a hopper for storing dispenser contents;
a removable hopper lid forming a substantially air-tight seal with the hopper; and
a dispensing chamber including
a first door for allowing the contents to pass from the hopper to the chamber when open and forming a substantially air-tight seal between the chamber and the hopper when closed,
a second door for allowing the contents to leave the chamber when open and retaining the contents in the chamber when closed, and
a measuring mechanism for measuring an amount of contents in the dispensing chamber.

2. The dispenser as set forth in claim 1, wherein the hopper lid includes a continuous, downwardly-opening channel proximate a periphery of the lid for receiving a top portion of a peripheral wall of the hopper.

3. The dispenser as set forth in claim 1, wherein the dispensing chamber further includes a peripheral chamber wall, at least a portion of the chamber wall being transparent.

4. The dispenser as set forth in claim 3, wherein the measuring mechanism includes measurement indicia proximate the substantially transparent portion of the chamber wall for determining an amount of contents in the dispensing chamber.

5. The dispenser as set forth in claim 3, the dispensing chamber further including
an upper door slot in the chamber wall; and
an inwardly-extending upper rib on an inside of the chamber wall proximate a top of the chamber wall, the upper rib running from a first end of the upper door slot along a portion of the wall not occupied by the slot to a second end of the upper door slot and presenting a continuous, inwardly-opening upper channel aligned with the upper door slot,
wherein the first door selectively slides through the upper door slot and into the upper channel, the first door snugly fitting the upper door slot and the upper channel to create a substantially air-tight seal.

6. The dispenser as set forth in claim 5, wherein the upper rib includes an upper lip above the upper channel and a lower lip below the upper channel, wherein the upper lip extends inwardly further than the lower lip and has an upper surface that slopes downwardly and inwardly from the chamber wall to an innermost edge of the upper rib.

7. The dispenser as set forth in claim 5, the dispensing chamber further comprising
a lower door slot in the chamber wall,
an inwardly-extending lower rib on the inside of the chamber wall proximate a bottom of the chamber wall, the lower rib running from a first end of the lower door slot along a portion of the wall not occupied by the slot to a second end of the lower door slot and presenting a continuous, inwardly-opening lower channel aligned with the lower door slot,
wherein the second door selectively slides through the lower door slot and into the lower channel, the second door snugly fitting the lower door slot and the lower channel to create a substantially air-tight seal.

8. The dispenser as set forth in claim 7, wherein the lower rib includes an upper lip above the lower channel and a lower lip below the lower channel that define the lower channel, wherein the upper lip extends inwardly further than the lower lip and has an upper surface that slopes downwardly and inwardly from the chamber wall to an innermost edge of the lower rib.

9. The ingredient dispenser as set forth in claim 1, the hopper including a peripheral outer wall and a funnel portion sloping inwardly from the peripheral outer wall toward the measuring chamber.

10. The dispenser as set forth in claim 1, wherein at least a portion of the hopper is transparent.

11. The dispenser as set forth in claim 1, wherein the hopper has a length and width each within the range of about four to about six inches, and a height within the range of about five to about seven inches.

12. The dispenser as set forth in claim 11, wherein the peripheral chamber has a length, width, and height each within the range of about two to about four inches.

13. The dispenser as set forth in claim 1, further comprising a mounting bracket attached to the hopper operable to removably attach the dispenser to an external mount.

14. The dispenser as set forth in claim 1, further comprising a handle attached to the hopper.

15. The dispenser as set forth in claim 1, further comprising a stand for supporting the hopper and the dispensing chamber in an elevated position.

16. A dispenser comprising:
a first continuous peripheral wall;
a lid presenting a continuous, downwardly-opening channel proximate a periphery of the lid, the channel receiving a top portion of the first peripheral wall and forming an air-tight seal with the top portion of the first peripheral wall;
a dispensing chamber including
a peripheral chamber wall, at least a portion of the chamber wall being transparent;
measurement indicia for measuring an amount of contents in the dispensing chamber,
an upper door slot in the chamber wall,
a lower door slot in the chamber wall,
an inwardly-extending upper rib on an inside of the chamber wall proximate a top of the chamber wall, the upper rib running from a first end of the upper door slot along a portion of the wall not occupied by the slot to a second end of the upper door slot and presenting a continuous, inwardly-opening upper channel aligned with the upper door slot,
an inwardly-extending lower rib on an inside of the chamber wall proximate a bottom of the chamber wall, the lower rib running from a first end of the lower door slot along a portion of the wall not occupied by the slot to a second end of the lower door slot and presenting a continuous, inwardly-opening lower channel aligned with the lower door slot;
a first door for selectively sliding through the upper door slot and into the upper channel, the first door snugly fitting the upper door slot and the upper channel to create a substantially air-tight seal;
a second door for selectively sliding through the lower door slot into the lower channel, the second door snugly fitting the lower door slot and the lower channel to create a substantially air-tight seal; and
a sloping peripheral wall extending inwardly from a bottom portion of the first peripheral wall toward a top portion of the chamber wall.

17. The dispenser as set forth in claim 16, wherein the upper rib includes an upper lip above the upper channel and a lower lip below the upper channel, wherein the upper lip extends inwardly further than the lower lip and has an upper surface that slopes downwardly and inwardly from the chamber wall to an innermost edge of the upper rib.

18. The dispenser as set forth in claim 16, wherein the lower rib includes an upper lip above the lower channel and a lower lip below the lower channel, wherein the upper lip extends inwardly further than the lower lip and has an upper surface that slopes downwardly and inwardly from the chamber wall to an innermost edge of the lower rib.

19. The dispenser as set forth in claim 16, wherein at least a portion of the first peripheral wall is transparent.

20. The dispenser as set forth in claim 16, wherein the first continuous peripheral wall forms a substantially square peripheral shape that is between four and six inches across and is between five and seven inches high.

21. The dispenser as set forth in claim 20, wherein the peripheral chamber wall forms a substantially square peripheral shape that is between two and four inches across and is between two and four inches high.

22. The dispenser as set forth in claim 16, further comprising a mounting bracket attached to the first peripheral wall operable to removably attach the dispenser to an external mount.

23. The dispenser as set forth in claim 16, further comprising a handle attached to the first peripheral wall.

24. A method of dispensing a dry ingredient, the method comprising:
placing a dry ingredient in a substantially air-tight dispenser hopper;
placing a lid on a top of the hopper to form a substantially air-tight seal between the lid and the hopper;
opening a first door located at a bottom of the hopper to allow the ingredient to fall into a dispensing chamber, the first door forming a substantially air-tight seal with the hopper when closed;
closing the first door;
opening a second door below the first door to allow the ingredient to fall out of dispensing chamber, the second door forming a substantially air-tight seal with the dispensing chamber when closed; and
closing the second door.

25. The method as set forth in claim 24, further comprising monitoring an amount of ingredient in the dispensing chamber via a transparent portion of the hopper and closing the first door when the amount of ingredient in the dispensing chamber corresponds to a pre-selected amount.
